(19) United States
(12) Patent Application Publication
(10) Pub. No.: US 2013/0058419 A1
(43) Pub. Date: Mar. 7, 2013

(54) WIRELESS VIDEO/AUDIO DATA TRANSMISSION SYSTEM

(71) Applicants: Zhou Ye, Foster City, CA (US); Tsung-Yu Chen, Taipei City (TW)

(72) Inventors: Zhou Ye, Foster City, CA (US); Tsung-Yu Chen, Taipei City (TW)

(21) Appl. No.: 13/225,485

(22) Filed: Sep. 5, 2011

(51) Int. Cl. H04N 7/26

(52) U.S. Cl. 375/240.25; 375/E07.027

(57) ABSTRACT

A wireless video/audio data transmission system for adjusting Phase-Locked-Loop (PLL) parameters to synchronize the rate of clock reference transmission in a decoder module is provided. The decoder requires no external DDR memory for performing frame buffering, and instead, an on-chip internal SRAM memory is provided as the frame buffer. Frame images are processed under compressed domain at the decoder module using the SRAM. Synchronization of reference frequency in decoder with the reference frequency in encoder allows for the SRAM to be utilized. Timing information for synchronizing decoding of the video/audio data is defined by timestamps sent at set interval. PLL is used for adjusting frequency of the decoder or encoder module. The PLL is adjusted up when reference frequency of encoder module is higher than reference frequency of decoder module and the corresponding timestamp value at encoder module is lower in comparison to corresponding timestamp value, and vice versa.

### BACKGROUND OF THE INVENTION

1. Technical Field

The present invention relates to a wireless video/audio data transmission system capable of adjusting Phase-Locked Loop (PLL) parameters. More particularly, this invention relates to a wireless video/audio data transmission system able to synchronize the rate of clock reference information transmitted from a video/audio data stream by adjusting the PLL residing in either a decoder or encoder module.

2. Description of Related Art

The increasing demand for digital wireless audio/video data presents an ever increasing problem of effectively controlling data transmission in a wireless audio/video transmitter receiver system. As the volume of audio/video data transmission increases in response to greater demand, it becomes increasingly more difficult to handle the large amount of transmitted audio/video information. Conventionally, the data streams contain video, audio, timing information and control data which are packaged and transmitted as a composite whole. The data, control elements, timing information and other information are arranged in various specific formats according to various standards, such as MPEG-1, MPEG-2, MPEG-4, h.264/AVC and others.

For supporting the requirements for high definition television, a High Definition Multimedia Interface (HDMI) receiver is typically used. HDMI receivers support an input reference clock frequency range of 25 MHz to 165 MHz. HDMI is an audio/video interface capable of transmitting uncompressed streams. Typically HDMI provides an interface between any compatible digital audio/video source, such as a set-top box, a DVD player, a PC, a video game console, or an audio video (AV) receiver and a compatible digital audio and/or video display or monitor, such as a high definition television (HDTV).

An important component of the video/audio data stream is the timing information which is used to synchronize the decoding and presentation of the video and audio data. For example, MPEG defines timing information in terms of timestamps or clock references. The MPEG standards permit an encoder to selectively adjust the transmission rate of timestamps in performing its encoding function. One restriction is that the time interval between timestamps must not exceed a specified range. On the other hand, timing information is essential for proper reproduction of the real-time video/audio data stream transmitted wirelessly.

In the conventional video decoder, such as H.264/AVC video decoder, for example, cache memory for frame buffering is usually provided in the form of an off-chip external DDR memory. Therefore, the DDR memory adds cost and integrated circuit footprint. Typically only fully-processed or decoded pixel data are stored in the DDR, instead of storing frame data in the compressed domain. Video playback is typically at 30 frames per second and at 720 p or 1080 p. Because the frame buffer has a limited memory, thus, only a small number of video frame data can be stored inside the DDR memory.

As described above, the cache buffer or frame buffer needs are typically satisfied at the Rx end by adding more external memory capacity as well as for facilitating display functions in the form of an off-chip DDR. Latency from encoding to decoding for conventional video decoders is typically more than 100 millisecond.

PLL is an electronic circuit that detects the frequency of an input signal and causes a Voltage-Controlled Oscillator (VCO) to match its output frequency to that of the input signal to effect synchronization. The PLL multiples its reference frequency to a desired output frequency by a ratio of integers. The frequency multiplication is exact, so that the PLL output frequency is precisely locked to the reference frequency. Therefore, if the reference frequency changes, the output frequency will then track exactly Conventional Phase-Locked Loop (PLL) typically includes a reference divider, a phase detector, a charge pump, a loop filter, a voltage-controlled oscillator (VCO) and a feedback divider. A post divider is often added for additional flexibility. The PLL works by adjusting the VCO speed faster or slower in response to the input and feedback clocks available at the phase detector inputs. A small value for the feedback and reference dividers increases the rate at which the phase detector is corrected by a clock signal.

Because video decoder module for conventional wireless video/audio transmitter receiver system requires of having an off-chip DDR memory to achieve the proper operation of the transmitter receiver system thereof, therefore, there is room for improvement in the art.

### SUMMARY OF THE INVENTION

One aspect of the invention is to provide a wireless video/audio data transmission system capable of adjusting a plurality of Phase-Locked Loop (PLL) parameters to synchronize the rate of clock reference information transmission from a data stream in a decoder module.

One aspect of the invention is to provide a wireless video/audio data transmission system capable of adjusting a plurality of Phase-Locked Loop (PLL) parameters to synchronize the rate of clock reference information transmission from a data stream in a encoder module.

Another aspect of the invention is to provide a wireless video/audio data transmission system without using an external DDR memory acting as the frame buffer.

Another aspect of the invention is to provide a wireless video/audio data transmission system using an on-chip internal SRAM memory acting as the frame buffer.

Another aspect of the invention is to provide a wireless video/audio data transmission system for processing pixel data or frame images under the compressed domain at the decoder module using the on-chip SRAM memory.

To achieve the foregoing and other aspects, the synchronization of the reference frequency in the decoder with the reference frequency in the encoder allows for having a smaller frame buffer in the form of an on-chip SRAM memory to be effectively utilized without having problems relating to displaying faulty images. Moreover, by synchronizing the reference frequency in the decoder with the reference frequency in the encoder, the frame buffer size can be effectively optimized to the extent that even the smaller frame buffer capacity of the SRAM found on-chip can be used to adequately and effectively support the needs for cache memory of the video decoder without requiring of having any larger off-chip DDR memory.

To achieve the foregoing and other aspects, underflow issues in the cache memory or frame buffer would be overcome by speeding up the encoder clock at the transmitter by sending periodic message from the decoder module.

To achieve the foregoing and other aspects, wireless transmission of video/audio data streams at for example 720 p or 1080 p are utilized.

To achieve the foregoing and other aspects, the PLL is configured to resolve discrepancies in reference frequency synchronization between the encoder and decoder modules caused by fluctuating time delay.

To achieve the foregoing and other aspects, the SRAM is disposed on the decoder IC of the decoder module.

To achieve the foregoing and other aspects, an adjusting circuit for adjusting the reference frequency in the decoder module with respect to the reference frequency in the encoder module so as to be synchronized is provided, wherein the adjusting circuit can be a PLL circuit.

To achieve the foregoing and other aspects, a plurality of timestamps, each sent at a set interval in the packet header is provided for detecting a timing difference in the encoder and the decoder, so that the PLL at the decoder can be adjusted up when the reference frequency of the encoder is too high and the corresponding timestamp value at the encoder is too low in comparison to the corresponding timestamp value at the decoder. In addition, the PLL at the decoder can be adjusted down when the reference frequency of the encoder is too low and the corresponding timestamp value at the encoder is too high in comparison to the corresponding timestamp value at the decoder.

To achieve the foregoing and other aspects, the counters used at the encoder and decoder are of 32 bits counters containing the timestamp values.

To achieve the foregoing and other aspects, the PLL includes a reference divider, a phase detector, a charge pump, a loop filter, a voltage-controlled oscillator (VCO) and a feedback divider. The PLL works by adjusting the VCO speed faster or slower in response to the input and feedback clocks available at the phase detector inputs. A small value for the feedback and reference dividers increases the rate at which the phase detector is corrected by a clock signal.

To achieve the foregoing and other aspects, a High-Definition Multimedia Interface (HDMI) I/O connector for transmitting uncompressed streams is provided between any compatible digital audio/video source, such as a set-top box, a DVD player, a PC, a video game console, or an audio video (AV) receiver and a compatible digital audio and/or video monitor, such as a digital television (DTV) to the decoder module at the receiver.

To achieve the foregoing and other aspects, a control logic generates a beacon pulse to be transmitted wirelessly as a control signal from the decoder to the encoder at a regular, predetermined period of the decoder local clock.

To achieve the foregoing and other aspects, the decoder uses a local clock to determine the timing of the data stream according to the timestamps value, and the encoder local clock and the decoder local clock are synchronized.

To achieve the foregoing and other aspects, the wireless encoder module and decoder module may communicate uni-directionally or bi-directionally.

To achieve the foregoing and other aspects, synchronization of the decoder sections with the channel is accomplished through the use of a PCR in the transport stream. The PCR is a timestamp and is used to derive the decoder timing.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a block diagram showing a wireless video/audio transmission system according to a first embodiment of present application.

FIG. 2 is a block diagram showing a conventional PLL having a Voltage-Controlled Oscillator (VCO).

FIG. 3 is a block diagram showing the timing information being defined in terms of timestamps, in which each timestamp is sent at set intervals in the packet header for detecting timing difference.

FIG. 4 is a block diagram showing a control logic generating a beacon pulse to be transmitted wirelessly as a control signal from the decoder module to the encoder module at a regular, predetermined period, according to an alternate embodiment.

FIG. 5 is a block diagram showing a decoder module which includes a video decoder section and an audio decoder section according to a fifth embodiment.

### DETAILED DESCRIPTION OF THE INVENTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

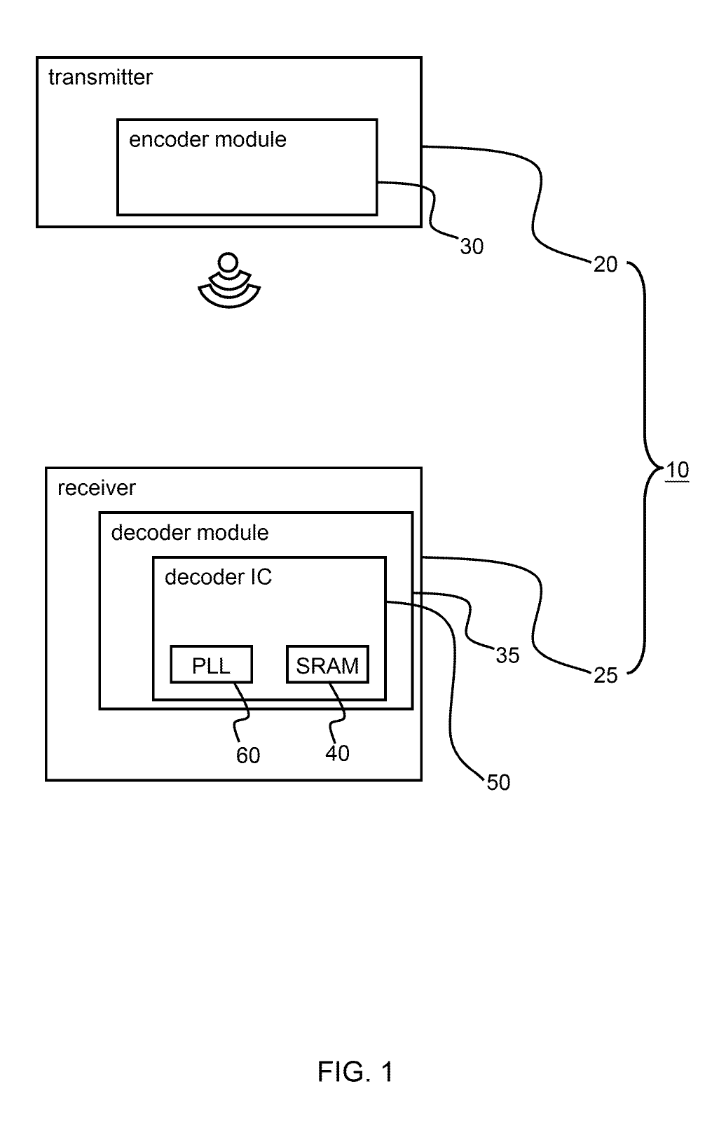

According to a first embodiment of present application, a wireless video/audio transmission system 10 is provided. Referring to FIG. 1, the wireless video/audio transmission system 10 includes a transmitter 20 and a receiver 25. The transmitter 20 includes an encoder module 30, and the receiver includes a decoder module 35. The transmitter 20 is attached to an electronic device (not shown) which contains a plurality of video/audio data ready for playback wirelessly through the transmitter 20 to the receiver 25. The receiver 25 is connected to a display device (not shown) such as a HDTV, ready for video/audio playback. The decoder module 35 provides video playback at 30 frames per second at 720 p or 1080 p. The video/audio data streams are wirelessly transmitted between the encoder module 30 and the decoder module 35. The time delay fluctuates periodically, thereby causing discrepancies in frequency synchronization between the encoder module 30 and the decoder module 35. A SRAM 40 is disposed on the decoder IC 50 (on-chip SRAM) of the decoder module 35. In the first embodiment, there is no DDR memory (not shown) found off-chip, thereby is thus able to reduce the overall IC footprint.

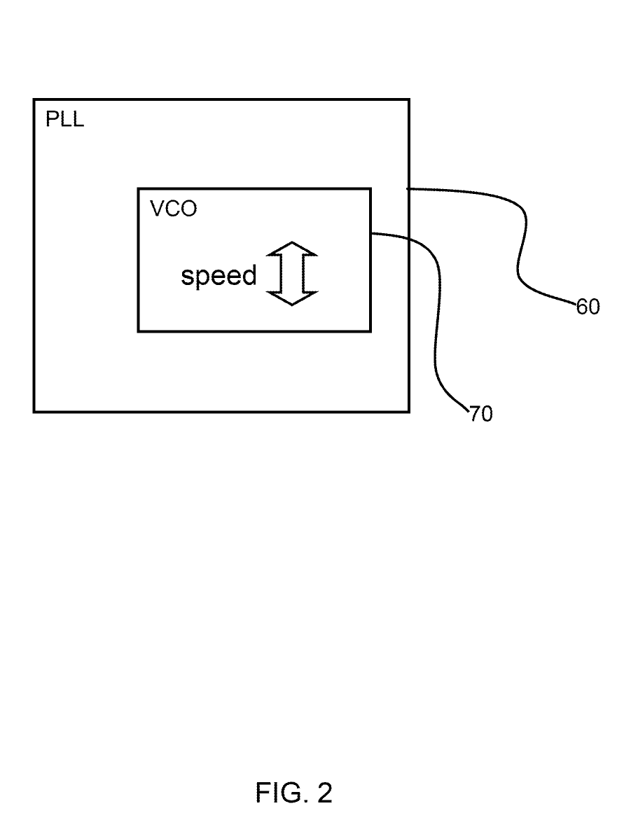

Referring again to FIG. 1, a PLL 60 is configured also in the decoder IC 50 of the decoder module 35. Referring to FIG. 2, the PLL 60 is a conventional PLL, which can adjust a Voltage-Controlled Oscillator (VCO) 70 to go faster or slower. In a second embodiment, the PLL 60 can be configured in the encoder module 30 instead, so that the encoder speed can be adjusted instead of the decoder speed. In the embodiments of instant application, the PLL 60 is an electronic circuit that detects the frequency of an input signal and causes a VCO 70 to match its output frequency to that of the input signal to effect synchronization. Referring to the first embodiment, the PLL 60 includes a reference divider (not shown), a phase detector (not shown), a charge pump (not shown), a loop filter (not shown), a voltage-controlled oscillator 70 and a feedback divider (not shown). In another embodiment, a post divider (not shown) is added for additional flexibility. The PLL 60 works by adjusting the VCO 70 speed faster or slower in response to the input and feedback clocks available at the phase detector inputs. A small value for the feedback and reference dividers increases the rate at which the phase detector is corrected by a clock signal. In the embodiments, the PLL 60 is configured to form an adjusting circuit 65 for adjusting a reference frequency value 36 in the decoder module 35 with a reference frequency value 31 in the encoder module 30 so as to be synchronized. The VCO 70 found in the PLL 60 can create the desired time difference.

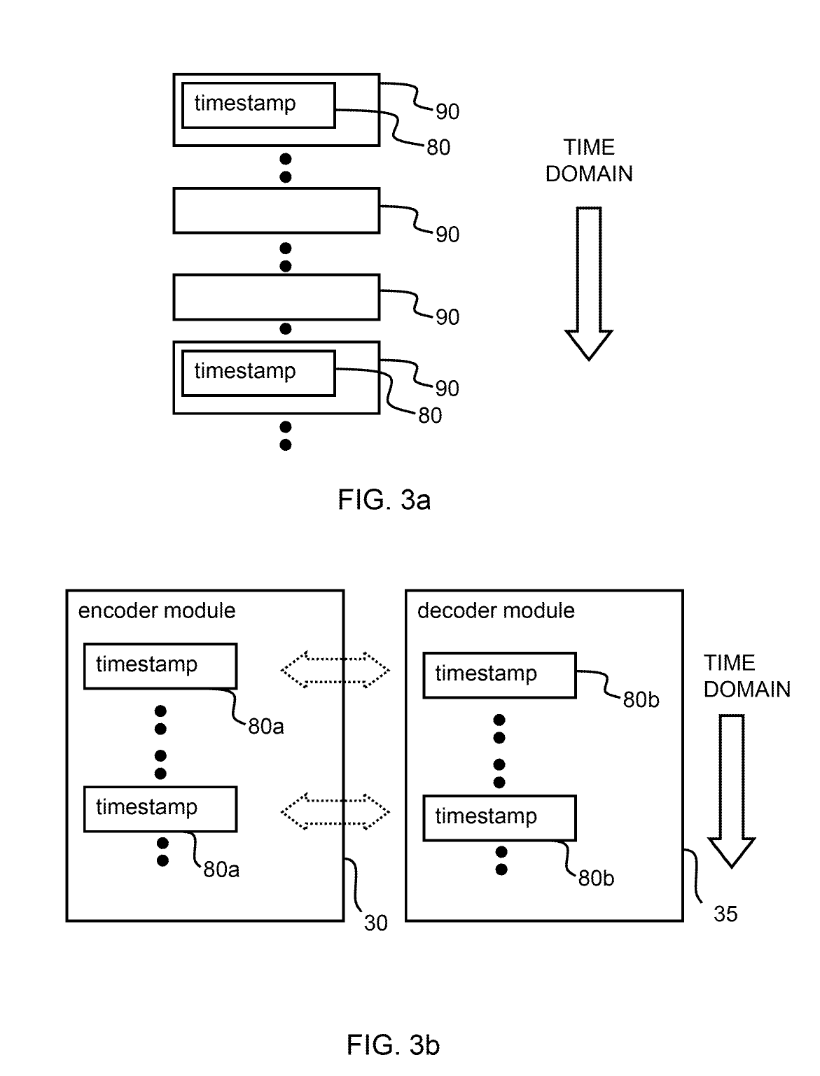

In the first embodiment, the system clock oscillates with +/−30 ppm tolerance. In addition, in the embodiments, a plurality of data streams contain video, audio, timing information and control data are packaged and transmitted as a composite whole. The data, control elements, timing information and other information are arranged in accordance with MPEG-4, h.264/AVC standard. The timing information is used to synchronize the decoding and presentation of the video and audio data. Referring to FIG. 3, in the various embodiments, the timing information is defined in terms of a plurality of timestamps 80. Moreover, each timestamp 80 are sent at 10 millisecond intervals, for example, in the packet header for detecting timing difference. It should be noted that the timestamp 80 is not found in every packet 90, but is instead configured in set interval of 10 milliseconds in the first embodiment, but is not limited to that, and can be configured at various time intervals depending upon specific requirements. The counter is set to count according to 27 MHz frequency to compare the local countertimestamp 80a. Based on the differences between the local counter timestamp values 80a, 80b in the encoder module 30 and the decoder module 35, the PLL 60 disposed at the decoder IC 50 can be adjusted up when the reference frequency of the encoder module 30 is too high by a first predefined amount and the corresponding timestamp 80a value at the encoder module 30 is too low in comparison to the corresponding timestamp 80b value at the decoder module 35 by a second predefined amount. In addition, the PLL 60 at the decoder module 35 can be adjusted down when the reference frequency of the encoder module 30 is too low by a first predefined amount and the corresponding timestamp 80a at the encoder module 30 is too high in comparison to the corresponding timestamp 80b value at the decoder module 35 by a second predefined amount. In the first embodiment, the counters used at the encoder module 30 and the decoder module 35 are of 32 bits containing the timestamp 80 values. In short, when the encoder module 30 is too fast, the PLL 60 (in the decoder module 35) is then adjusted higher. Then when the encoder module 30 is too slow, the PLL 60 is adjusted lower. The timestamp 80 is found in the frame header (not shown). It is noted that there is no requirement for having any display memory to be stored in any off-chip DDR according to the embodiments of instant application. Therefore, the PLL 60 is able to effectively provide synchronization between the frequencies at the encoder module 30 and the decoder modules 35 without requiring a cache buffer such as a conventional DDR memory.

According to the embodiments of instant application, a larger external DDR memory acting as the frame buffer is omitted, and instead at least one SRAM 40 is found in the decoder module 35. The SRAM 40 is a smaller pre-existing on-chip internal SRAM found on the decoder IC 50. The operating performance of the SRAM 40 is faster than the conventional DDR memory. According to a third embodiment, transmission latency for using the SRAM 40 has been achieved to be around 50 milliseconds from encoding to decoding as compared to be around 100 millisecond for latency in conventional system. According to a fourth embodiment, the frame buffer or cache can be implemented with a custom voltage scalable SRAM to minimize memory access power, and the SRAM 40 can be a single-port on-chip SRAM cache.

In the first embodiment, the receiver 25 is a receiver with a HDMI interface which must support an input reference clock frequency range of 25 MHz to 165 MHz. In the first embodiment, the encoder module 30 at the transmitter 20 is a wireless module, and generates a local clock, the cycles of the local clock is counted during a common timing reference period maintained wirelessly between the encoder module 30 and the decoder module 35, a timestamp 80 of the decoder clock is received during the same common timing reference period, and the local clock signal of the encoder module 30 is then adjusted based upon a comparison of the two timestamps 80a, 80b (of the encoder clock with respect to the decoder clock). For the first embodiment, the wireless decoder module 35 further receives timing references from the encoder module 30 and, in addition, receives packets of data samples from the encoder module 30 accompanied by a timestamp 80, the timestamp 80 is based upon the encoder timing reference, and outputs the data sample at the time designated by the timestamp 80. In the embodiments, the wireless encoder module 30 and the wireless decoder module 35 may communicate unidirectionally or bidirectionally.

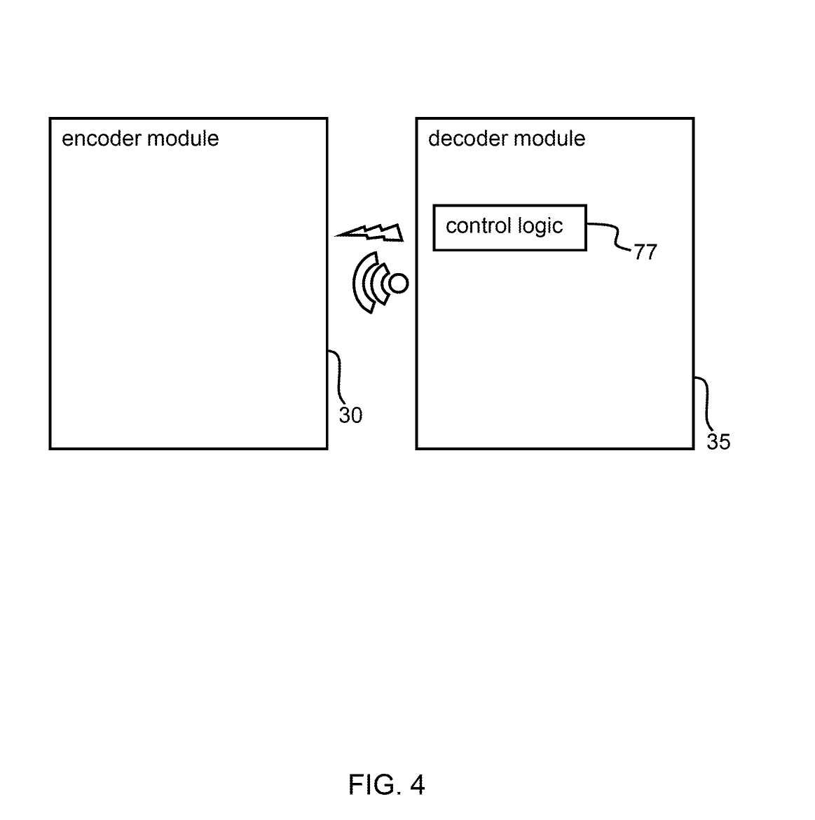

Referring to FIG. 4, for an alternate embodiment, a control logic 77 generates a beacon pulse to be transmitted wirelessly as a control signal from the decoder module 35 to the encoder module 30 at a regular, predetermined period of the decoder local clock. In addition, the wireless video/audio transmission system 10 can be a wireless video/audio data transmission gateway device, for example.

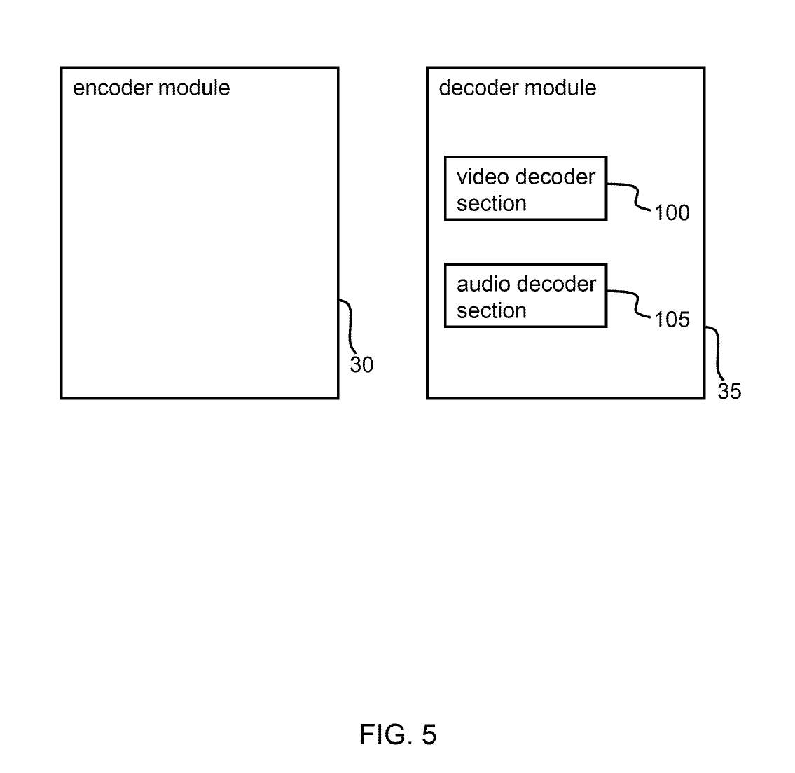

In a fifth embodiment, video data and audio data are encoded into a plurality of elementary video and audio bitstreams at the encoder module 30. These bitstreams are then converted into packets. The packets are received and multiplexed to produce a transport stream. The transport stream is transmitted over a transmission channel, which may further incorporate separate channel specific encoder and decoder (not shown). Next, the transport stream is demultiplexed and decoded by a transport stream demultiplexor (not shown), where the elementary bitstreams serve as inputs to the decoder module 35. Referring to FIG. 5, the decoder module 35 includes a video decoder section 100 and an audio decoder section 105, whose outputs are decoded video signals on path and audio signals on path respectively. Furthermore, timing information is also extracted by the transport stream demultiplexor and delivered to the clock control for synchronizing the video decoder section 100 and the audio decoder section 105 with each other and with the channel. In this embodiment, synchronization of the decoder sections 100, 105 with the channel is accomplished through the use of the PCR in the transport stream. The PCR is a timestamp 80. More specifically, clock control incorporates the PLL 60 which evaluates the PCR to effect adjustment of a VCO 70, thereby achieving synchronization. Initialization sets the value in the counter of the decoder module 35 to be equal to that of the value of the counter of the encoder module 30. When the reference frequency of the decoder module 35 is synchronized with the encoder module 30, both counters containing their respective timestamp values 80a, 80b are counting synchronously.

According to the embodiments of instant application, overall memory usage for the wireless video/audio transmission system is reduced by omitting a larger external DDR memory acting as the frame buffer, to use instead, a much smaller internal SRAM. As a result, the quantity of memory components for the wireless video/audio transmission system is reduced by eliminating the DDR memory. In the conventional art, only fully-processed pixels are stored in the off-chip memory of the DDR. On the other hand, pixel data in compressed domain are stored in the SRAM 40 according to the embodiments of instant application.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A wireless video/audio data transmission system, comprising:
a transmitter, the transmitter having an encoder module therein;
a receiver, the receiver having a decoder module therein; and
and a SRAM, the SRAM is disposed and configured in the decoder module,
wherein the transmitter is connected to an electronic device providing a plurality of video/audio data streams, the receiver is connected to a display device for enabling video/audio playback, and the data streams are wirelessly transmitted between the encoder module and the decoder module, without using a DDR memory in the decoder module.

2. The system as claimed in claim 1, wherein the SRAM is an on-chip internal SRAM memory acting as the frame buffer.

3. The system as claimed in claim 1, wherein the SRAM is a single-port on-chip SRAM cache.

4. The system as claimed in claim 1, wherein the data streams are stored in only compressed domain in the SRAM at the decoder module.

5. The system as claimed in claim 1, wherein the decoder module provides video playback at 30 frames per second at 720 p or 1080 p.

6. The system as claimed in claim 1, wherein the transmission latency from encoding to decoding is around 50 milliseconds.

7. A wireless video/audio transmission system, comprising:
a transmitter, the transmitter having an encoder module therein;
a receiver, the receiver having a decoder module therein;
an adjusting circuit; and
a SRAM,
wherein the adjusting circuit and the SRAM are configured in the decoder module, a plurality of video/audio data streams are wirelessly transmitted between the encoder module and the decoder module, without using a DDR memory coupled to the decoder module, and the speed of the adjusting circuit is adjusted for synchronizing the reference frequency in the decoder module with the reference frequency in the encoder module.

8. The system as claimed in claim 7, wherein the adjusting circuit is a Phase-Locked-Loop (PLL), and the PLL comprising a voltage-controlled oscillator (VCO).

9. The system as claimed in claim 8, wherein the PLL is configured to provide frequency synchronization between the encoder module and the decoder module.

10. The system as claimed in claim 9, wherein the timing information for synchronizing the decoding of the video and audio data stream is defined by a plurality of timestamps sent at a plurality of set intervals, a counter used at the encoder module and the decoder module is a 32 bits counter containing the timestamp, respectively, and the timestamp is in the frame header.

11. The system as claimed in claim 10, wherein the PLL is adjusted up when the reference frequency of the encoder module is higher than the reference frequency of the decoder module by a first predefined amount and the corresponding timestamp value at the encoder module is lower than the corresponding timestamp value at the decoder module by a second predefined amount.

12. The system as claimed in claim 10, wherein the PLL is adjusted down when the reference frequency of the encoder module is lower than the reference frequency of the decoder module by a first predefined amount and the corresponding timestamp value at the encoder module is higher than the corresponding timestamp value at the decoder module by a second predefined amount

13. A wireless video/audio transmission system, comprising:
a transmitter, the transmitter having an encoder module therein;
a receiver, the receiver having a decoder module therein;
a Phase-Locked-Loop (PLL), the PLL comprising a voltage-controlled oscillator (VCO); and
a SRAM,
wherein the PLL is configured in the encoder module and the SRAM is configured in the decoder module, a plurality of video/audio data streams are wirelessly transmitted between the encoder module and the decoder module, without using a DDR memory coupled to the decoder module, the speed of the VCO of the PLL is adjusted faster or slower for synchronizing the reference frequency in the decoder module with the reference frequency in the encoder module.

14. The system as claimed in claim 13, wherein the receiver has a High Definition Multimedia Interface (HDMI) Interface.

15. The system as claimed in claim 13, further comprising a control logic, and the control logic generating a beacon pulse transmitted wirelessly as a control signal from the decoder module to the encoder module at a predetermined period for relaying timing information from the decoder module to the encoder module for adjusting the PLL settings.
